(19) United States
(12) Patent Application Publication
(10) Pub. No.: US 2005/0129030 A1
(43) Pub. Date: Jun. 16, 2005

(54) Multiple shared LAN emulation method in EPON based on group ID

(76) Inventors: Su Il Choi, Daejeon-city (KR); Tae Il Kim, Daejeon-city (KR); Hyeong Ho Lee, Daejeon-city (KR)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/934,605

(22) Filed: Sep. 2, 2004

(30) Foreign Application Priority Data
Dec. 13, 2003 (KR) 2003-90968

(51) Int. Cl. H04L 12/28

(52) U.S. Cl. 370/395.53

(57) ABSTRACT

A multiple shared LAN emulation method in an EPON based on a group ID is provided. A group ID (GID) is defined, and rules for processing an Ethernet frame are defined in each OLT and each ONU using a mode value, an LLID value, and a GID value so that a plurality of LANs are established in the EPON. Thus, a plurality of LANs are established in the OLT, and an independent network is provided to each of a plurality of service providers.

### BACKGROUND OF THE INVENTION

This application claims the priority of Korean Patent Application No. 2003-90968, filed on Dec. 13, 2003, in the Korean Intellectual Property Office, the disclosure of which is incorporated herein in its entirety by reference.

1. Field of the Invention

The present invention relates to an Ethernet passive optical network (EPON), and more particularly, to a LAN emulation method in the EPON.

2. Description of the Related Art

Currently, a passive optical network (PON) system based on Ethernet, that is, an Ethernet passive optical network (EPON) system has been used to provide wide-band services economically. IEEE802.3ah Ethernet first mile (EFM) is proceeding to standardization of the EPON system.

In general, the PON system has a structure in which a passive optical distribution network (ODN) is connected between optical line terminal (OLT) and fiber to the home (FTTH) optical network terminations (ONTs) or fiber to the curb/cabinet (FTTC) optical network units (ONUs). All nodes are topology distributed in the form of a bus or tree structure.

The EPON system has a point-to-multipoint structure in which a plurality of ONUs share an optical line terminal (OLT) at a central office connected to optical cables via the passive ODN. The EPON system is suitable for broadcasting services due to the point-to-multipoint structure. However, the EPON system requires the function of establishing a virtual local area network (VLAN) to provide an independent service network for each subset of ONUs which is connected to the same OLT, and this is used for provider separation or service group separation.

### SUMMARY OF THE INVENTION

The present invention provides a multiple shared LAN emulation method in an Ethernet passive optical network (EPON) capable of establishing a plurality of LANs in an optical line terminal (OLT) and providing an independent network for each of a plurality of service providers. By defining a group ID (GID) and providing filtering and marking rules using a mode value, a logical link ID (LLID) value, and a GID value, an OLT provides a plurality of LANs established without the help of virtual local area network (VLAN) services in ONUs.

According to an aspect of the present invention, there is provided a multiple shared LAN emulation method in an Ethernet passive optical network (EPON) via which an optical line terminal (OLT) and a plurality of optical subscriber units are connected. The method includes splitting the optical subscriber units into groups for provider separation or service group separation and allocating group IDs to each of the split groups; storing a mode value representing whether a corresponding frame is a unicast frame or a broadcast frame, a group ID value, and a logical link identifier (LLID) with respect to the optical subscriber units in a preamble of an Ethernet frame; if a frame is input to the OLT, receiving the frame input from the optical subscriber units which belong to the groups, by referring to the group ID value and the LLID value stored in the preamble of the input frame; and if the frame is input to the optical subscriber units, receiving the frame input from the OLT or a frame input from another optical subscriber unit, by referring to the mode value, the group ID value, and the LLID value stored in the preamble of the input frame.

According to another aspect of the present invention, there is provided a multiple shared LAN emulation method in an optical line terminal (OLT) connected to a plurality of optical subscriber units in an Ethernet passive optical network (EPON). The method includes if a frame is input, determining whether a group ID value stored in a preamble of the frame is identical with one of the group ID values stored in the OLT; if it is determined that the group ID value is identical with one of the stored group ID values, determining whether a logical link identifier (LLID) value of an optical subscriber unit stored in the preamble of the frame is identical with one of the stored LLID value; and if it is determined that the LLID value of the frame is identical with one of the stored LLID values, receiving the frame.

According to still another aspect of the present invention, there is provided a multiple shared LAN emulation method in a plurality of optical subscriber units connected to an optical line terminal (OLT) in an Ethernet passive optical network (EPON). The method includes if a frame is input, determining whether a mode value stored in a preamble of the input frame represents a unicast frame or a broadcast frame; if it is determined that the frame is the unicast frame, when a group ID value stored in the preamble of the frame and a logical link identifier (LLID) value of an optical subscriber unit are identical with its own group ID value and LLID value, receiving the frame; if it is determined that the frame is the broadcast frame, determining whether the frame is input from the OLT or the optical subscriber unit; if it is determined that the frame is the broadcast frame input from the OLT, receiving a frame in which the group ID value stored in the preamble of the frame of an optical subscriber unit is identical with its own group ID value; and if it is determined that the frame is the broadcast frame input from the optical subscriber unit, receiving a frame in which the group ID value stored in the preamble of the frame and the logical link identifier (LLID) value of an optical subscriber unit are identical with its own group ID value and LLID value and discarding the frame if the frame is a frame transmitted from itself.

### BRIEF DESCRIPTION OF THE DRAWINGS

The above aspects and advantages of the present invention will become more apparent by describing in detail exemplary embodiments thereof with reference to the attached drawings in which:

FIG. 1 is a block diagram showing the structure of an Ethernet passive optical network (EPON) system according to the present invention;

FIG. 2 shows the format of an Ethernet frame of the EPON system according to an embodiment of the present invention; and

FIGS. 3 and 4 show rules of frame reception in an OLT system and an ONU system according to an embodiment of the present invention.

### DETAILED DESCRIPTION OF THE INVENTION

Hereinafter, exemplary embodiments of the present invention will be described in detail with reference to the accompanying drawings.

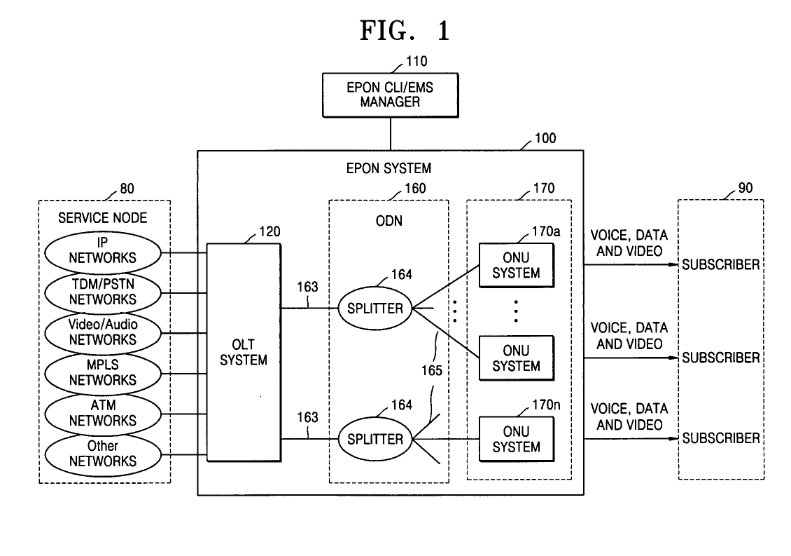

FIG. 1 is a block diagram showing the structure of an Ethernet passive optical network (EPON) system according to the present invention. Referring to FIG. 1, an EPON system 100, which is placed at a root of a tree structure, includes an optical line terminal (OLT) system 120, an optical distribution network (ODN) 160, and a plurality of optical network unit (ONU) systems 170.

The OLT system 120 is a service provider's terminal, converts an electrical signal into an optical signal, and provides the optical signal to each EPON subscriber. In other words, the OLT system 120 connects a variety of subscriber traffic to a service node 80 that supports IP networks, time division multiplex (TDM)/public switched telephone network (PSTN) networks, video/audio networks, multiprotocol label switching (MPLS) networks, asynchronous transfer mode (ATM) networks, and other networks. In the connection of the subscriber traffic, the OLT system 120 defines a group ID (GID) for each ONU in a preamble contained in a frame header and establishes multiple shared LANs for processing an Ethernet frame in consideration of the GID defined for each ONU. As a result, an independent network is provided to each of a plurality of service providers.

The ODN 160 is connected to the OLT system 120 and the ONU system 170 and splits the optical signal transmitted from the OLT system 120 into a plurality of optical signals. To this end, the ODN 160 includes a plurality of optical lines 163 and 165 and a plurality of passive splitters 164.

Each of the ONU systems 170 is connected to the OLT system 120 via the ODN 160, and performs subscriber interface for supporting data, video, and voice services and interface for upstream traffic transmitted to the OLT system 120. In this case, each of ONU systems 170a, . . . , and 170n process the Ethernet frame in consideration of the GID tagged in the preamble of the frame header received from the OLT system 120. As a result, OLT provides a plurality of LANs, and these can be used for provider separation or service group separation.

The whole operating management of the EPON system 100 having the above structure is performed via an EPON common line interface (CLI) or an element management system (EMS) manager 110 connected to the OLT system 120.

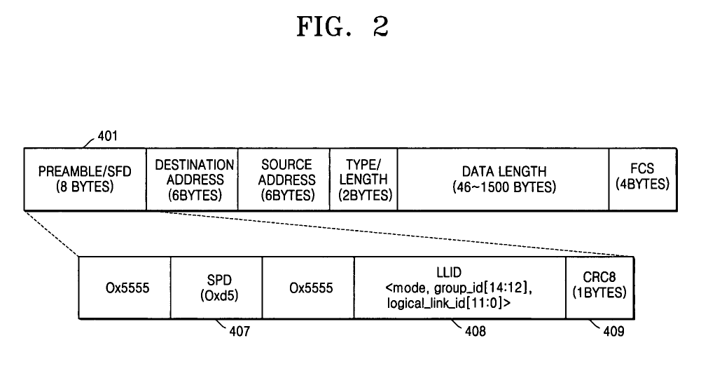

FIG. 2 shows the format of an Ethernet frame of the EPON system 100 according to an embodiment of the present invention. The detailed structure of a preamble is shown in FIG. 2. Exchange rules of a preamble/SFD 401 are shown in Table 1.

Referring to FIG. 2, the Ethernet frame, which is transmitted to and received from the OLT system 120 and the ONU system 170, includes a preamble/start-of-frame delimiter (SFD) 401, a destination address field, a source address field, a type/length field, and a frame check sequence (FCS) field. The preamble/SFD 401 includes a start of packet delimiter (SPD) field 407, a logical link ID (LLID) field 408, and a cyclic redundancy check (CRC) field 409.

As shown in FIG. 2 and Table 1, the LLID field 408 is comprised of a 1-bit area [15] in which a mode value is stored, a 3-bit area [14:12] in which a group ID (GID) is stored, and a 12-bit area [11:0] in which a logical link ID (LLID) is stored.

The mode value is allocated as 0 or 1 to the 1-bit area [15] by the OLT system 120. When the mode value is allocated to the 1-bit area [15] by the ONU system 170, the mode value is designated as 0. The mode value ‘0’ means a unicast frame, and the mode value ‘1’ means a broadcast frame. For example, when the mode value is designated as 1 by the OLT system 120, a broadcasting function for transmitting packets to all ONUs is supported. When the mode value is designated as 1, the LLID value of an input packet is identical with the LLID value of a specific ONU system, all ONU systems excluding a corresponding ONU receive packets.

Since the GID value is represented as 3 bits, the GID value may be used by designating eight groups from GID=0 to GID=7. In general, GID=0 may be used in a case where the GID value is not designated. The GID value is used in a case where a plurality of ONU systems (or ONT systems) are split into predetermined groups and GIDs are allocated to each of the split groups.

Since the LLID value is comprised of 12 bits, 4,096 (maximum) ONUs or ONTs can be connected to an OLT link. The LLID value is used as a value representing a source ONU system 170 when the frame is transmitted from the ONU system 170 to the OLT system 120 and a value representing a destination ONU system 170 when the frame is transmitted from the OLT system 120 to the ONU system 170. The LLID value represents a specific ONU system with respect to a plurality of ONU systems 170a, . . . , and 170n connected to an OLT system 120 and is a logical link identifier or a logical port number which represents the specific ONU system. The ONU system 170 transmits LLID information allocated by the OLT system 120 to the OLT system 120 when transmitting packets to the OLT system 120. Since the LLID value is a representative value of the ONU system, a unique should be allocated to an ONU or ONT. The aforementioned GID is used to designate a plurality of ONUs or ONTs having different LLID values.

TABLE 1

| Offset | Fields | Preamble/SFD | Modified preamble/SFD |
|---|---|---|---|
| 1 | — | 0 × 55 | the same |
| 2 | — | 0 × 55 | the same |
| 3 | SPD | 0 × 55 | 0 × d5 |
| 4 | — | 0 × 55 | the same |
| 5 | — | 0 × 55 | the same |
| 6 | LLID[15:8] | 0 × 55 | <mode, group ID[14:12], LLID |
| | | | [11:8]> |
| 7 | LLID[7:0] | 0 × 55 | <LLID [7:0]> |
| 8 | CRC8 | 0 × d5 | 8-bit CRC from offset 3 to 7 |

Although each LLID value and each GID value with respect to the aforementioned ONU or ONT are not shown in FIG. 2, the values are managed by the OLT system 120 in the form of a table and are used in determining from where packets received from the OLT system 120 are received. Each ONU or ONT stores its own LLID value and GID value designated by the OLT system 120, and the values are used in determining whether packets transmitted from the OLT system 120 are processed.

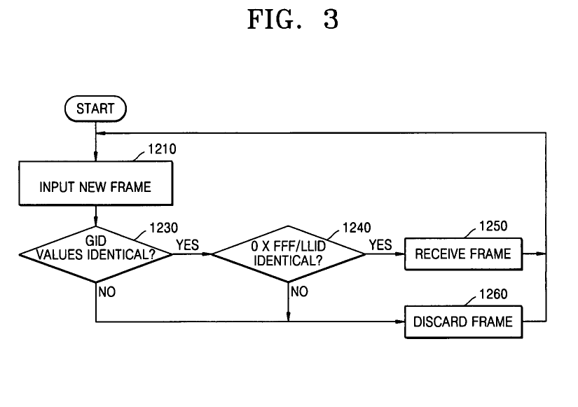

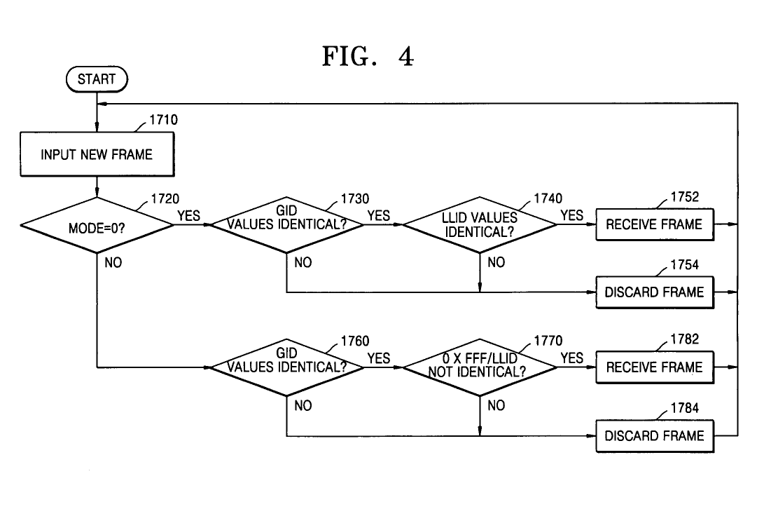

FIGS. 3 and 4 show rules of frame reception in the OLT system 120 and the ONU system 170 according to an embodiment of the present invention.

Procedures for processing a frame of the OLT system 120 with respect to the frame transmitted from the ONU system 170 will now be described with reference to FIG. 3.

If a new frame is input in operation 1210, in operation 1230, it is determined whether a GID value (that is, a GID value which an ONU or ONT transmits to packets) is identical with any one of GID values managed by the OLT system 120, by referring to the LLID field 408 contained in the preamble 401 of the input frame.

As a determination result of operation 1230, if the GID value is not identical with any one of GID values, in operation 1260, a corresponding frame is discarded. If the GID value is identical with any one of GID values, in operation 1240, it is determined whether an LLID value set in the LLID field 408 of the input frame (that is, an LLID value which an ONU or ONT transmits to packets) is identical with any one of LLID values managed by the OLT system 120 or whether the LLID value has a value of 0×FFF.

As a determination result of operation 1240, if the LLID value is not identical with any one of LLID values, in operation 1260, the corresponding frame is discarded. If the LLID value is identical with any one of LLID values or has the value of 0×FFF, in operation 1250, the corresponding frame is received. Here, the case where the LLID value has the value of 0×FFF means an initial state in which the LLID value of the ONU or ONT which has transmitted the frame is not set.

Procedures for processing a frame of the ONU system 170 with respect to the frame transmitted from the OLT system 120 will now be described with reference to FIG. 4.

If a new frame is input in operation 1710, in operation 1720, the ONU system 170 checks whether a mode value set in the LLID field 408 is 0, by referring to the LLID field 408 contained in the preamble 401 of the input frame. Here, a mode value 0 means a unicast frame, and a mode value 1 means a broadcast frame.

As a checking result of operation 1720, if the mode value is 0, in operation 1730, it is determined whether a GID value set in the LLID field 408 of the input frame is identical with its own GID value. As a determination result of operation 1730, if the GID value is not identical with its own GID value, in operation 1754, a corresponding frame is discarded. If the GID value is identical with its own GID value, in operation 1740, it is determined whether an LLID value set in the LLID field 408 of the input frame is identical with its own LLID value. As a determination result of operation 1740, if the LLID value is not identical with its own LLID value, in operation 1754, the corresponding frame is discarded. If the LLID value is identical with its own LLID value, in operation 1752, the corresponding frame is received.

As a checking result of operation 1720, if the mode value is not 0 (that is, if the mode value is 1), in operation 1760, it is determined whether the GID value set in the LLID field 408 of the input frame is identical with its own GID value. As a determination result of operation 1760, if the GID value is not identical with its own GID value, in operation 1784, the corresponding frame is discarded. If the GID value is identical with its own GID value, in operation 1770, it is determined whether an LLID value set in the LLID field 408 of the input frame is not identical with its own LLID value or has a value of 0×FFF. Here, determining whether the LLID value has a value of 0×FFF is to check whether the input broadcast frame is transmitted from the OLT 120. Determining whether the LLID value is not identical with its own LLID value is to determine whether when a broadcast frame is transmitted to and received from ONUs, the input broadcast frame is transmitted from the ONU.

As a determination result of operation 1770, if the LLID value is identical with its own LLID value (that is, when the broadcast frame is transmitted to and received from the ONUs, if the input broadcast frame is transmitted from the ONU), in operation 1784, the corresponding frame is discarded. As a determination result of operation 1770, if the LLID value is not identical with its own LLID value (that is, when the broadcast frame is transmitted to and received from the ONUs, if the input broadcast frame is input from another ONU) or has the value of 0×FFF (that is, if the input broadcast frame is input from the OLT 120), in operation 1782, the corresponding frame is received.

As described previously, in the multiple shared LAN emulation method according to the present invention, a group ID (GID) is defined, and a corresponding frame is processed in each group using a mode value, an LLID value, and a GID value. Using GID, OLT provides multicasting frames to the specific subset of ONUs, and this means OLT provides complete implementation of virtual local area network (VLAN) in Ethernet passive optical network (EPON). Thus, an independent network is provided to each of a plurality of service providers.

The invention can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion.

As described above, in the multiple shared LAN emulation method in the EPON based on the group ID according to the present invention, a group ID (GID) is defined, and rules for processing an Ethernet frame are defined in each OLT and each ONU using a mode value, an LLID value, and a GID value so that a plurality of LANs are established in the EPON. Thus, a plurality of LANs are established in the OLT, and an independent network is provided to each of a plurality of service providers.

While the present invention has been particularly shown and described with reference to exemplary embodiments thereof, it will be understood by those of ordinary skill in the art that various changes in form and details may be made therein without departing from the spirit and scope of the present invention as defined by the following claims.

1. A multiple shared LAN emulation method in an Ethernet passive optical network (EPON) via which an optical line terminal (OLT) and a plurality of optical subscriber units are connected, the method comprising:
splitting the optical subscriber units into groups for provider separation or service group separation and allocating group IDs to each of the split groups;
storing a mode value representing whether a corresponding frame is a unicast frame or a broadcast frame, a group ID value, and a logical link identifier (LLID) with respect to the optical subscriber units in a preamble of an Ethernet frame;
if a frame is input to the OLT, receiving the frame input from the optical subscriber units which belong to the groups, by referring to the group ID value and the LLID value stored in the preamble of the input frame; and
if the frame is input to the optical subscriber units, receiving the frame input from the OLT or a frame input from another optical subscriber unit, by referring to the mode value, the group ID value, and the LLID value stored in the preamble of the input frame.

2. A multiple shared LAN emulation method in an optical line terminal (OLT) connected to a plurality of optical subscriber units in an Ethernet passive optical network (EPON), the method comprising:
if a frame is input, determining whether a group ID value stored in a preamble of the frame is identical with one of the group ID values stored in the OLT;
if it is determined that the group ID value is identical with one of the stored group ID values, determining whether a logical link identifier (LLID) value of an optical subscriber unit stored in the preamble of the frame is identical with one of the stored LLID value; and
if it is determined that the LLID value of the frame is identical with one of the stored LLID values, receiving the frame.

3. A multiple shared LAN emulation method in a plurality of optical subscriber units connected to an optical line terminal (OLT) in an Ethernet passive optical network (EPON), the method comprising:
if a frame is input, determining whether a mode value stored in a preamble of the input frame represents a unicast frame or a broadcast frame;
if it is determined that the frame is the unicast frame, when a group ID value stored in the preamble of the frame and a logical link identifier (LLID) value of an optical subscriber unit are identical with its own group ID value and LLID value, receiving the frame;
if it is determined that the frame is the broadcast frame, determining whether the frame is input from the OLT or the optical subscriber unit;
if it is determined that the frame is the broadcast frame input from the OLT, receiving a frame in which the group ID value stored in the preamble of the frame of an optical subscriber unit is identical with its own group ID value; and
if it is determined that the frame is the broadcast frame input from the optical subscriber unit, receiving a frame in which the group ID value stored in the preamble of the frame and the logical link identifier (LLID) value of an optical subscriber unit are identical with its own group ID value and LLID value and discarding the frame if the frame is a frame transmitted from itself.
